(19) United States
(12) Patent Application Publication
(10) Pub. No.: US 2026/0026631 A1
(43) Pub. Date: Jan. 29, 2026

(54) BED FRAME AND BED FRAME CONNECTION STRUCTURE

(71) Applicant: Peter Wu, Arlington, TX (US)

(72) Inventor: Peter Wu, Arlington, TX (US)

(21) Appl. No.: 18/784,221

(22) Filed: Jul. 25, 2024

(51) Int. Cl. A47C 19/02; F16B 12/56

(52) U.S. Cl. CPC A47C 19/028; A47C 19/024; F16B 12/56

(57) ABSTRACT

A simple bed base connection structure includes a connecting part, groove parts on both sides of the connecting part for connection with outer rails of adjacent bed frames, a locking member that is detachably connected to the connecting part, and an edge retainer. When the locking member is connected and locked with the connecting part, the edge retainer presses the frame of each adjacent bed frame into the groove parts. The bed base connecting structure allows for easy assembly and easy expansion from a small bed to a large bed.

### BACKGROUND

This disclosure relates the technical field of furniture, in particular to a simple bed frame or base connection structure and simple bed frame or base.

At present, simple bed frame structures are relatively large in size. When the bed is required for use it needs to be assembled, and currently the bed frame contains many parts. Adjacent bed frames are connected through multiple screw assemblies or hinge assemblies, making the overall packaging size relatively large, causing inconvenient assembly and high transportation costs.

### SUMMARY

The present disclosure relates generally to a connection structure for bed frames.

The purpose of this disclosure is to provide a simple bed frame connection structure in view of the above-mentioned shortcomings and defects of prior bed bases. This connection structure enables quick bed frame assembly, contains fewer parts, reduces packaging size, and transportation costs. These measures solve the above mentioned technical issues. The second object of this disclosure is to provide a simple bed base.

The technical problems solved by the disclosed connection structure and bed frame are accomplished as follows.

Preferred embodiments disclosed herein include a simple bed base connection structure which includes a connecting part, groove parts on both sides of the connecting part for connection with the adjacent bed frame, a locking member that is detachably connected to the connecting part, and an edge retainer. When the locking member is connected and locked with the connecting part, the edge retainer presses the frame of each adjacent bed frame into the groove parts.

In a preferred embodiment, the detachable connection between the locking member and the connecting part includes a threaded connection.

In a further preferred embodiment, an assembly hole is provided in the middle of the connecting part, an inner wall of the assembly hole is provided with internal threads, and the locking member has an externally threaded rod that cooperates with the internal threads.

In a further preferred embodiment, a mounting hole is provided in the middle of the connecting part, a nut is provided on the mounting hole, and the locking member has an externally threaded rod that cooperates with the nut.

In a further preferred embodiment, the edge retainer is in the form of a circular ring structure fixed on one end of the locking member facing the groove parts.

In a further preferred embodiment, a through hole is provided in the middle of the connecting part, the edge retainer features a T-shaped structure, and the vertical edge of the edge retainer passes through the through hole and features an inner threaded hole, the locking member has an externally threaded rod that matches the internally threaded hole.

In a further preferred embodiment, the width of the groove parts is adapted to the outer diameter of the rails of the adjacent bed frames to which the groove parts will attach, and the height is smaller than the adjacent bed frame.

Additional preferred embodiments relate to a simple bed base that includes at least two bed frames, and the adjacent bed frames are connected through a connecting structure by any one of the connection structures described herein.

In a further preferred embodiment, the length of the locking member matches the length of the bed frame leg, so that the locking member can also serve as the bed leg.

In a further preferred embodiment, each bed frame includes a bed outer frame and a plurality of transverse frames arranged in parallel at intervals within the bed outer frame, as well as a plurality of transverse frames arranged in parallel at intervals within the bed outer frame.

Compared with the prior art, the simple bed base connection structure described in preferred embodiments herein can enable quick bed frame assembly, contains fewer parts, reduces packaging size, and reduces transportation costs. The bed base and connection structure features a simple structure that is easy to assemble, and may be utilized to allow for easy bed expansion, allowing users to change bed sizes at their will. In addition, the connection structure which results in a steadier structure.

### BRIEF DESCRIPTION OF THE DRAWINGS

In order to more clearly explain the embodiments of the bed frame connection structure and bed frame described herein or its associated technical solutions, the attached drawings described below will be used in the description. The drawings discussed in the following description are only some embodiments of the connection structure and bed frame or base. Those skilled in the art will recognize that further preferred embodiments exist that are not explicitly illustrated in these drawings.

FIG. 1 shows a schematic structural diagram of a preferred embodiment of a bed base connection structure as described herein.

FIG. 2 is an exploded schematic diagram of the structure of a preferred embodiment of a bed base connection structure as described herein.

FIG. 3 is a partial enlarged view of a preferred embodiment of a bed base connection structure as described herein.

FIG. 4 is a partial cross-sectional view of a preferred embodiment of a bed base connection structure as described herein.

FIG. 5 is a partial cross-sectional view of a preferred embodiment of a bed base connection structure as described herein.

FIG. 6 is a partial cross-sectional view of a preferred embodiment of a bed base connection structure as described herein.

FIG. 7 is a schematic structural diagram of a preferred embodiment of a bed base connection structure and bed base as described herein.

FIG. 8 is a schematic structural diagram of a preferred embodiment of a bed base connection structure and bed base as described herein.

### DETAILED DESCRIPTION OF PREFERRED EMBODIMENTS

The present disclosure relates to a bed frame or base connection structure and a bed frame or base.

In order to better describe the technical and creative features, purpose and efficacy of the connection structure and bed base, the connection structure and bed base are further described below with reference to preferred embodiments and associated drawings.

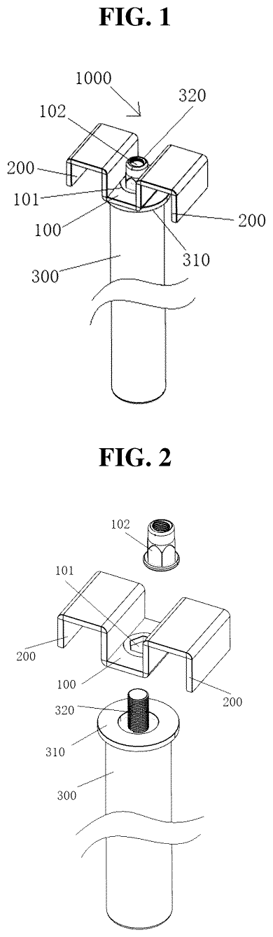

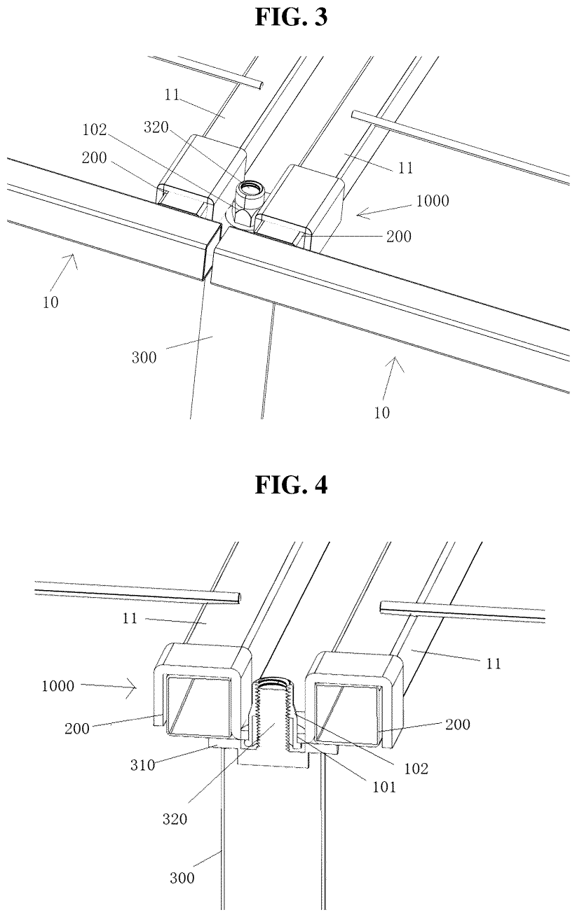

A bed base connection structure 1000 is shown in FIGS. 1 to 4, including connecting part 100 and groove parts 200 provided on both sides of the connection part 100. The groove parts 200 are used to connect with adjacent bed frames 10 on outer bed frame rails 11 shown in FIGS. 3 and 4. In this embodiment, the connecting part 100 includes a metal plate, and the groove part 200 is in an inverted “U” shape standing vertically on both sides of the connecting part 100. The connecting part 100 and the groove part 200 are integrally formed, and the connecting part 100 is arranged between the two groove parts. Bed base connection structure 1000 also includes locking member 300. The locking member 300 is detachably connected to the connecting part 100. The locking member 300 is provided with a structure for pressing the outer bed frame rails 11 of the adjacent bed frames 10 into the groove parts. The edge retainer 310 presses the outer bed frame rails 11 of each adjacent bed frame 10 into the groove parts 200 after the locking member 300 is connected and locked with the connecting part 100.

The detachable connection method between the locking member 300 and the connecting part 100 may include a threaded connection. In this embodiment, the connecting part 100 is provided with a mounting hole 101, a nut 102 is provided on the mounting hole 101, and the locking member 300 has an externally threaded rod 320 that cooperates with nut 102. The nut 102 can be welded to the mounting hole 101, or a blind rivet nut can be used to directly fix it to the mounting hole 101. Of course, the connecting part 100 may also be provided with an assembly hole, where the inner wall of the assembly hole is provided with internal threads, and the locking member 300 has an externally threaded rod that matches the internal threads. It is also possible to utilize a detachable connection between the locking member 300 and the connecting part 100. The locking member 300 may be a long rod.

The edge retainer 310 of the embodiment shown in FIGS. 2 and 4 is in the form of an annular structure. The central axis of the edge retainer of the annular structure in this embodiment coincides with the central axis of the externally threaded rod 320.

The interior width of the groove parts 200 is adapted to substantially match the outer diameter of outer bed frame rails 11 of the adjacent bed frames 10, without being too wide or too narrow, to allow for a close and stable fit, and the interior height of the groove part 200 is smaller than the height of outer bed frame rails 11 of the adjacent bed frames 10. In this embodiment the outer bed frame rails 11 are shaped like square tubes.

When base connection structure 1000 is matched with the adjacent bed frames 10, outer bed frame rails 11 of the adjacent bed frames 10 are placed into the groove parts 200, and then the locking member 300 is tightened. During the tightening process of the locking member 300, the edge retainer 310 will contact the bottom of outer bed frame rails 11 to press outer bed frame rails 11 into the groove parts 200 to complete the connection. Bed base connection structure 1000 enables quick assembly of a bed frame with fewer parts and reduced transportation costs.

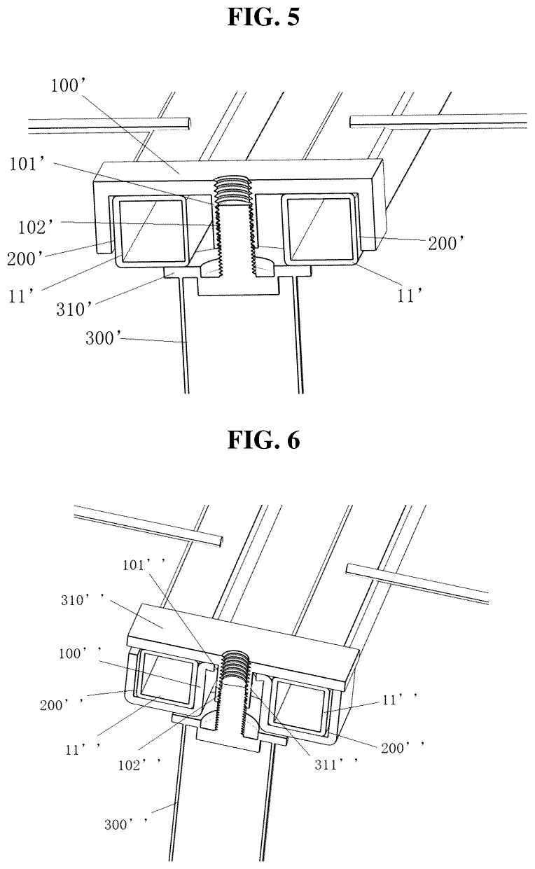

FIG. 5 shows an additional preferred embodiment. In this embodiment, nuts are not utilized and instead the mounting holes are replaced with assembly holes 101′. The inner wall of the assembly hole 101′ is provided with internal threads 102′. When the locking member 300′ is connected and locked with the connecting part 100′, the edge retainer 310′ presses outer bed frame rails 11′ of each adjacent bed frame into the groove parts 200′.

FIG. 6 shows an additional preferred embodiment. In this embodiment, nuts are not utilized and instead the mounting hole is a through hole 101″. This embodiment includes edge retainer 310″ as a T-shaped structure, where a vertical edge 311″ of the edge retainer 310″ passes through the through hole 101″ and has an internal threaded hole 102″, and two sides of the connecting part 100″. The opening of the groove part 200″ is changed from downward to upward. When the locking member 300″ is connected and locked with the connecting part 100″, the edge retainer of the T-shaped structure 310″ presses outer bed frame rails 11″ of the adjacent bed frames into the groove part 200″.

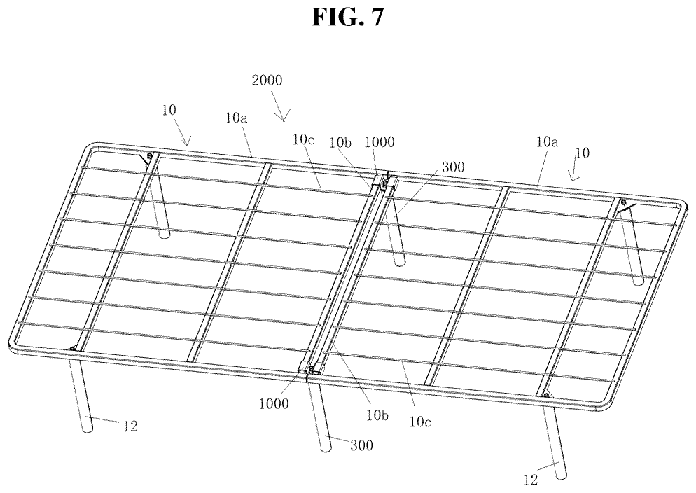

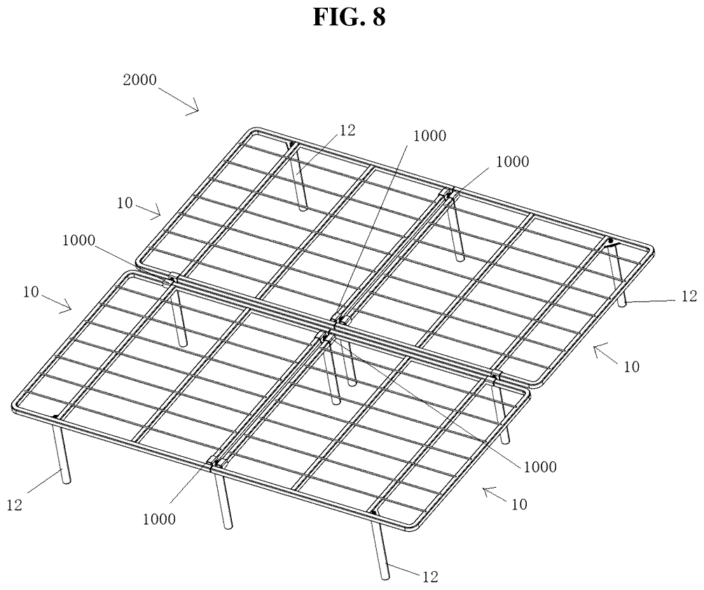

As shown in FIGS. 7 and 8, a bed base 2000 includes at least two adjacent bed frames 10, and the adjacent bed frames 10 are connected through embodiments of the bed base connection structure 1000 described herein. Preferably, the length of the locking member 300 matches the length of the bed leg 12 of the bed frame 10, so that the locking member 300 doubles as a foot of the bed, and there is no need to assemble the foot of the bed separately in this position. The bed leg 12 can be connected to the bed frame 10 using threads. Each bed frame 10 includes a bed outer frame 10a, a plurality of transverse frame rails 10b arranged in parallel at intervals within the bed outer frame 10a, and a plurality of vertical frame rails 10c arranged in parallel at intervals within the bed outer frame 10a and perpendicular to the transverse frame rails 10b.

The bed frame connection structure described herein allows for an easy change between a small bed and a large bed. When a small bed is needed, as shown in FIG. 7, the two adjacent bed frames 10 are connected through a simple bed base connection structure 1000. When a large bed is required, as shown in FIG. 8, four adjacent bed frames 10 are connected through bed base connection structures 1000. The bed base connection structure 1000 can be provided on both sides of the docking sides of adjacent bed frames 10. In the embodiment shown in FIG. 8, six bed base connection structures 1000 are used to connect adjacent bed frames 10.

The basic principles and main features of the present disclosure and the advantages of the bed base connection structure are shown and described above. Industry professionals should understand that the present disclosure is not limited by the above-mentioned examples. The above-mentioned examples and descriptions only illustrate the principles of the preferred embodiments. Without departing from the spirit and scope of the present invention, there can also be various changes and improvements in the described embodiments, and these changes and improvements all fall within the scope of the invention.

What is claimed is:

1. A bed base connecting structure for connecting adjacent bed frames, where each adjacent bed frame includes an outer bed frame rail, comprising:
a connecting part;
groove parts located on both sides of the connecting part for connecting with the outer bed frame rails of the adjacent bed frames;
a locking member detachably connected to the connecting part; and
an edge retainer located on the locking member, wherein when the locking member is connected to the connecting part, the edge retainer presses the outer bed frame rails of the adjacent bed frames into the groove parts to connect the adjacent bed frames.

2. The bed base connecting structure of claim 1, wherein the locking member further comprises a threaded connection for detachably connecting to the connecting part.

3. The bed base connecting structure of claim 1, wherein the connecting part comprises an assembly hole located in the middle of the connecting part, wherein the assembly hole comprises an internal thread, and wherein the locking member further comprises an external threaded rod for engaging with the internal thread of the assembly hole.

4. The bed base connecting structure of claim 1, wherein the bed base connecting structure further comprises a nut, wherein the connecting part comprises a mounting hole located in the middle of the connecting part, wherein the locking member further comprises an external threaded rod for passing through the mounting hole and engaging with the nut.

5. The bed base connecting structure of claim 1, wherein the edge retainer is an annular structure located on an end of the locking member.

6. The bed base connecting structure of claim 1, wherein the connecting part comprises a through hole located in the middle of the connecting part, wherein the edge retainer is a T-shaped structure comprising a vertical portion with an internally threaded hole, wherein the vertical portion is configured to pass through the through hole, and wherein the locking member further comprises an external threaded rod for engaging with the internally threaded hole of the vertical portion.

7. The bed base connecting structure of claim 1, wherein the groove parts have an interior width adapted to substantially match an external width of the outer bed frame rails, and wherein the groove parts have an interior height that is smaller than the external height of the outer bed frame rails.

8. A bed base for assembly, comprising:
at least two adjacent bed frames, where each adjacent bed frame comprises an outer bed frame rail;
a connecting part;
groove parts located on both sides of the connecting part for connecting with the outer bed frame rails of the adjacent bed frames;
a locking member detachably connected to the connecting part; and
an edge retainer located on the locking member, wherein when the locking member is connected to the connecting part, the edge retainer presses the outer bed frame rails of the adjacent bed frames into the groove parts to connect the adjacent bed frames.

9. The bed base of claim 8, wherein the adjacent bed frames comprise legs, and wherein a height of the legs is substantially the same as a height of the locking member.
